(19) United States
(12) Patent Application Publication
(10) Pub. No.: US 2015/0210025 A1
(43) Pub. Date: Jul. 30, 2015

(54) SYSTEM FOR MOLDING NON-PNEUMATIC TIRES

(71) Applicant: CATERPILLAR INC., Peoria, IL (US)

(72) Inventor: Kevin Lee Martin, Washburn, IL (US)

(73) Assignee: CATERPILLAR INC., Peoria, IL (US)

(21) Appl. No.: 14/163,865

(22) Filed: Jan. 24, 2014

(51) Int. Cl. B29D 30/02; B29C 67/00; B29C 33/38; B29C 33/76

(52) U.S. Cl. CPC B29D 30/02; B29C 33/76; B29C 67/0051; B29C 33/3842

(57) ABSTRACT

A removable insert for a tire mold used to manufacture a non-pneumatic tire is disclosed. The removable insert includes a first end, a second end, a body, an inner cavity, and an insert retaining feature. The second end is distal to the first end. The body extends between the first end and the second end. The inner cavity extends within the body from the first end towards the second end. The inner cavity includes an inner cavity surface. The insert retaining feature is located at inner cavity surface proximal the first end.

### TECHNICAL FIELD

The present disclosure generally pertains to a system for molding parts, and is more particularly directed toward a system for molding non-pneumatic tires.

### BACKGROUND

Non-pneumatic tires may be formed by molding. However, some molded non-pneumatic tires may be typically less compressible than similar-sized pneumatic tires. This reduced compressibility may render the non-pneumatic tires unsuitable for some desired uses. However, it is possible to increase the compressibility of some non-pneumatic tires by creating axially-extending cavities in the tires between the tread and the hub. Molds for creating these non-pneumatic tires may be complex, expensive to create, and expensive to modify.

U.S. Pat. No. 8,061,398 to R. Palinkas discloses a non-pneumatic tire along with a mold for forming the non-pneumatic tire. The non-pneumatic tire comprises side cavities that are staggered with respect to laterally opposing side cavities, and laterally extending tread grooves that are either in substantial radial alignment with the cavities or substantially offset relative to the cavities. Also provided are processes for making such tires and to off-the-road vehicles employing such tires.

The present disclosure is directed toward overcoming one or more of the problems discovered by the inventors or that is known in the art.

### SUMMARY OF THE DISCLOSURE

In one aspect, the present disclosure is directed to a removable insert for a tire mold used to manufacture a non-pneumatic tire is disclosed. The removable insert includes a first end, a second end, a body, an inner cavity, and an insert retaining feature. The second end is distal to the first end. The body extends between the first end and the second end. The inner cavity extends within the body from the first end towards the second end. The inner cavity includes an inner cavity surface. The insert retaining feature is located at inner cavity surface proximal the first end.

In another aspect, the present disclosure is directed to a method for modifying a mold with a mold bottom assembly and a mold top assembly for a non-pneumatic tire. The mold bottom assembly and the mold top assembly each include cavity rods extending from a plate. At least one rod is covered by an insert. The insert includes a body extending from a first end to a second end and an inner cavity extending into the body from the first end towards the second end. The method includes coupling a compressed air source to an air hole extending through the body from the inner cavity to the second end. The method also includes removing the insert by supplying compressed air form the compressed air source and by applying a force in a first direction from the first end to the second end. The method further includes coupling the compressed air source to a second air hole of a second insert, the second insert including an outer geometry that is different than the insert. The method yet further includes covering the at least one rod with the second insert by inserting the at least one rod into a second inner cavity of the second insert while supplying compressed air from the compressed air source and applying a force in a second direction opposite the first direction.

### BRIEF DESCRIPTION OF THE DRAWINGS

FIG. 1 is a perspective view of a tire mold for molding non-pneumatic tires.

FIG. 2 is a cross-sectional view of the tire mold of FIG. 1.

FIG. 3 is a perspective view of the bottom plate of the tire mold of FIG. 1.

FIG. 4 is a cross-sectional view of a portion of the mold bottom assembly for the tire mold of FIG. 1.

FIG. 5 is a cross-sectional view of a portion of the mold bottom assembly for the tire mold of FIG. 1.

FIG. 6 is a cross-sectional view of a portion of the mold bottom assembly for the tire mold of FIG. 1.

FIG. 7 is a cross-sectional view of the mold bottom assembly for the tire mold of FIG. 1.

FIG. 8 is a cross-sectional view of a bottom cavity insert assembled onto a bottom cavity rod for the mold bottom assembly of FIG. 7.

FIG. 9 is a cross-sectional view of the bottom cavity insert of FIG. 8 taken along the line IX-IX.

FIG. 10 is a cross-sectional view of the bottom cavity insert of FIG. 8 taken along the line X-X.

FIG. 11 is a cross-sectional view of a portion of the mold top assembly for the tire mold of FIG. 1.

FIG. 12 is a cross-sectional view of the mold top assembly for the tire mold of FIG. 1.

FIG. 13 is a cross-sectional view of the tire mold of FIG. 1 with the mold top assembly removed from the mold bottom assembly.

FIG. 14 is perspective view of a rapid prototype tooling for molding an insert for the tire mold of FIG. 1 with the top portion removed.

FIG. 15 is a perspective view of the rapid prototype tooling of FIG. 14 partially demolded.

FIG. 16 is an exemplary tire molded with the tire mold of FIG. 1.

FIG. 17 is a flowchart of a method for molding a non-pneumatic tire 50 using the tire mold of FIGS. 1-11.

FIG. 18 is a flowchart of a method for modifying the tire mold of FIGS. 1-13.

FIG. 19 is a flowchart of a method for forming inserts for the tire mold of FIGS. 1 to 13.

### DETAILED DESCRIPTION

The systems and methods disclosed herein include a tire mold. In embodiments, the tire mold includes a mold bottom assembly and a mold top assembly with each including a plate, cavity rods, tread rods, cavity inserts, and tread inserts. Cavity inserts cover cavity rods and tread inserts cover tread rods. The radial pattern of cavity rods and tread rods along with the shapes of cavity inserts and tread inserts define the shape of a non-pneumatic tire molded with the tire mold. The cavity inserts and tread inserts may be removed and replaced to quickly modify the tire mold to form a non-pneumatic tire with a different shape including the shapes of the support structure and the tread.

The systems and methods disclosed herein may further include rapid prototype tooling. In embodiments, the rapid prototype tooling is a clamshell mold formed from a rapid prototyping method, such as additive manufacturing. The use of rapid prototype tooling may allow for a new design for a tire may be quickly implemented by generating the rapid prototype tooling for new cavity inserts or tread inserts, forming the new cavity inserts or tread inserts, and replacing the previous cavity inserts and tread inserts with the new ones.

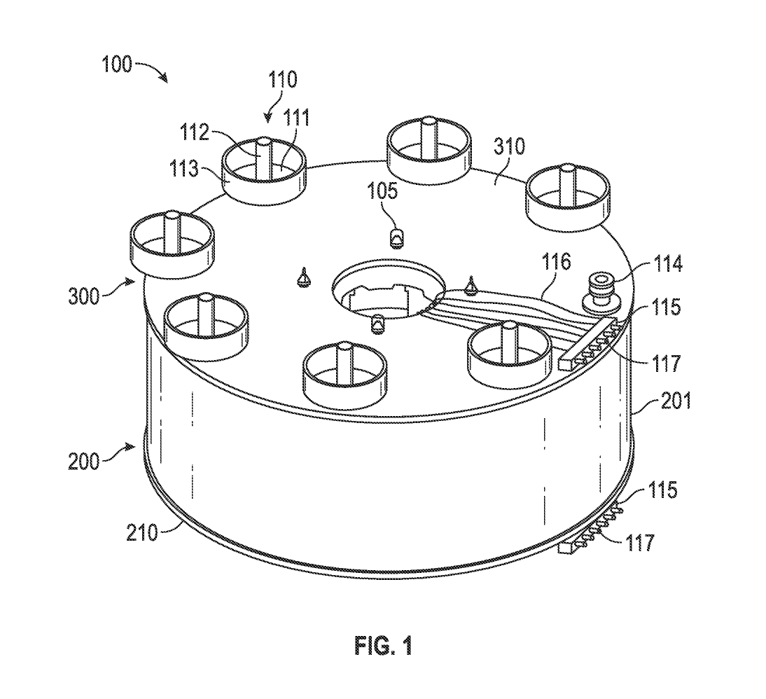

FIG. 1 is a perspective view of a tire mold 100 for molding non-pneumatic tires. Some of the surfaces may have been left out or exaggerated (here and in other figures) for clarity and ease of explanation. Also, the disclosure may generally reference a center axis 101 of the tire mold 100. The center axis 101 may be common to or shared with various concentric components of tire mold 100. All references to radial, axial, and circumferential directions and measures refer to center axis 101, unless specified otherwise, and terms such as “inner” and “outer” generally indicate a lesser or greater radial distance from center axis 101, wherein a radial may be in any direction perpendicular and radiating outward from center axis 101.

Tire mold 100 includes a mold bottom assembly 200 and a mold top assembly 300. As illustrated in FIG. 1, mold bottom assembly 200 includes a bottom plate 210 and an outer band 201. Bottom plate 210 may include an annular disk shape. Outer band 201 extends in an axial direction from bottom plate 210 and may include a hollow cylinder shape. Outer band 201 is coupled to bottom plate 210. Mold top assembly 300 includes a top plate 310. Top plate 310 may also include an annular disk shape. When mold top assembly 300 is joined with mold bottom assembly 200, outer band 201 abuts top plate 310 distal to bottom plate 210.

Tire mold 100 also includes a port 114 and one or more overflow pans 110 coupled to top plate 310. Port 114 is configured to fluidly couple with a material source for filling the tire mold 100 with the material to be used for the non-pneumatic tire. Each overflow pan 110 may include a pan base 111 and a pan rim 113 extending from an outer circumference of pan base 111. Pan base 111 may be an annular disk shape and pan rim 113 may be a hollow cylinder shape. Each overflow pan 110 may also include a vent tube 112 extending up from pan base 111.

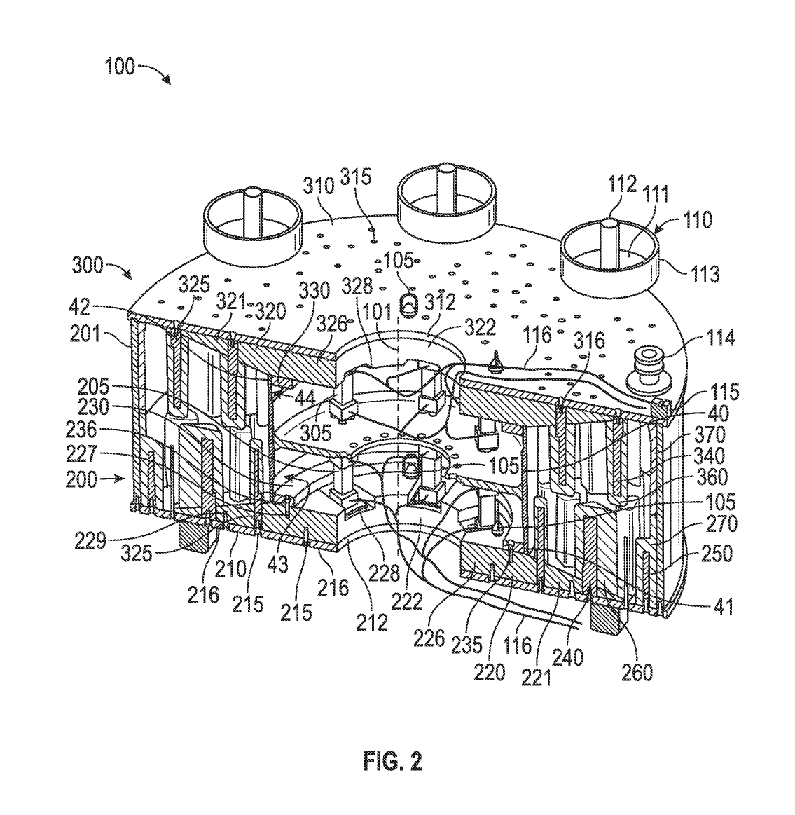

Tire mold 100 may include hooks 105 connected to mold top assembly 300 and mold bottom assembly 200 (shown in FIG. 2). Hooks 105 connected to mold top assembly 300 may be used to lift mold top assembly 300 when joining mold top assembly 300 to mold bottom assembly 200 or when removing mold top assembly 300 from mold bottom assembly 200. Hooks 105 connected to mold bottom assembly 200 may be used to relocate/move mold bottom assembly 200.

Tire mold 100 may also include one or more hydraulic manifolds 115 configured to supply hydraulic power to bottom hydraulic cylinders 205 (shown in FIG. 2) and top hydraulic cylinders 305 (shown in FIG. 2) through hydraulic hoses 116. Each hydraulic manifold 115 includes quick connects 117 for connecting the hydraulic manifold 115 to a hydraulic power source. In the embodiment illustrated in FIG. 1, tire mold 100 includes a hydraulic manifold 115 coupled to top plate 310 for supplying hydraulic power to top hydraulic cylinders 305 and a hydraulic manifold 115 coupled to bottom plate 210 for supplying hydraulic power to bottom hydraulic cylinders 205.

FIG. 2 is a cross-sectional view of the tire mold 100 of FIG. 1. The embodiment illustrated in FIG. 2 shows a rim 40 inserted into tire mold 100. Rim 40 includes a first cylindrical end 41 and a second cylindrical end 42 distal to the first cylindrical end 41. First cylindrical end 41 and second cylindrical end 42 are axial ends of rim 40. Rim 40 also includes a first surface portion 43 and a second surface portion 44. First surface portion 43 is cylindrical, faces radially inward, and is adjacent first cylindrical end 41. Second surface portion 44 is cylindrical, facing faces radially inward, and is adjacent second cylindrical end 42. The tire is generally molded onto rim 40. In the embodiment illustrated in FIG. 2, mold bottom assembly 200 includes bottom plate 210, bottom conical plate 220, bottom locating ring 230, bottom hydraulic cylinders 205, outer band 201, bottom cavity rods 240, bottom tread rods 250, bottom cavity inserts 260, and bottom tread inserts 270; and mold top assembly 300 includes top plate 310, top conical plate 320, top locating ring 330, top hydraulic cylinders 305, top cavity rods 340, top tread rods 350 (shown in FIG. 11), top cavity inserts 360, and top tread inserts 370.

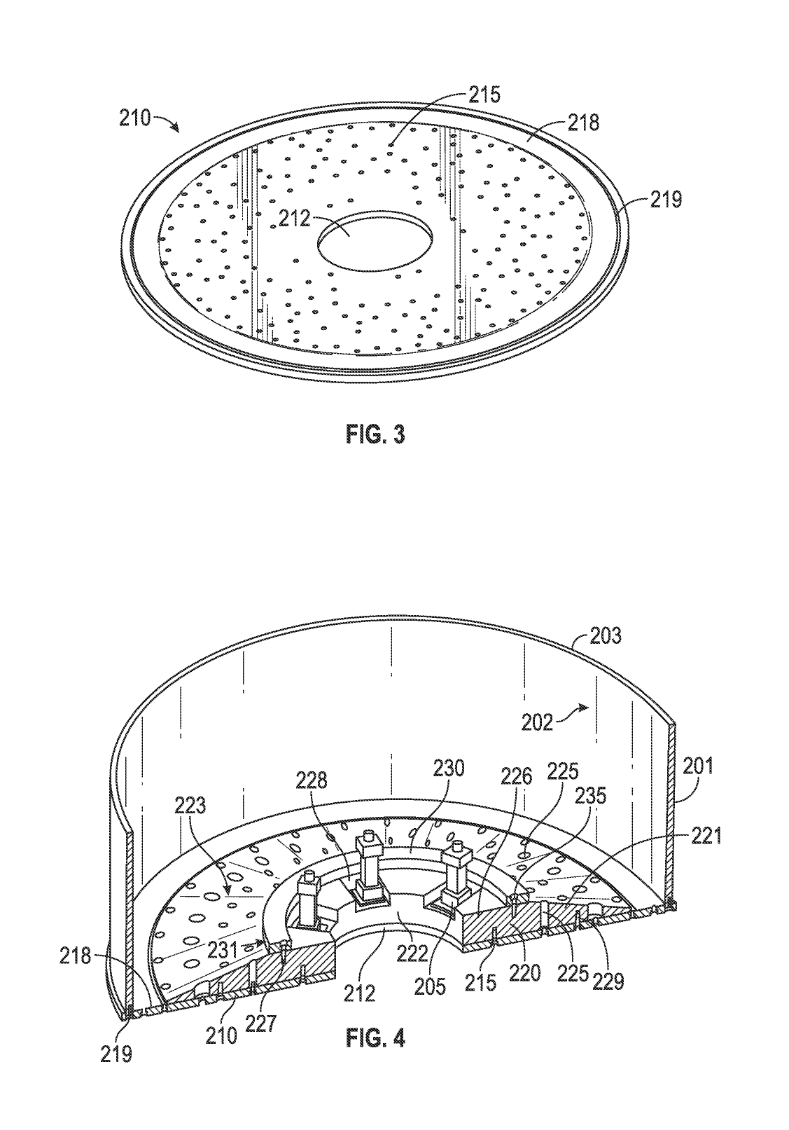

FIG. 3 is a perspective view of the bottom plate 210 of the mold bottom assembly 200 of FIG. 1. Bottom plate 210 may include a bottom plate bore 212, bottom fastening holes 215, a bottom outer band slot 219, and a bottom ridge 218. Bottom plate bore 212 may be concentric to bottom plate 210 and to center axis 101 when bottom plate 210 is assembled to tire mold 100. Bottom fastening holes 215 extend through bottom plate 210 and may be used for securing bottom conical plate 220 to bottom plate 210, bottom cavity rods 240 to bottom plate 210, and bottom tread rods 250 to bottom plate 210. Bottom fastening holes 215 may be selectively located to form a pattern, such as a radial pattern, with bottom cavity rods 240 and bottom tread rods 250. Bottom fastening holes 215 may be located radially outward from bottom plate bore 212. Referring to FIG. 2, bottom fasteners 216 may be used to secure bottom conical plate 220, bottom cavity rods 240, and bottom tread rods 250 to bottom plate 210.

Bottom outer band slot 219 may be adjacent the outer circumference of the bottom plate 210. Bottom outer band slot 219 may be located radially outward from bottom plate bore 212 and bottom fastening holes 215. Bottom outer band slot 219 may be an annular shape. Outer band 201 may be inserted into bottom outer band slot 219 when being coupled to bottom plate 210. Outer band 201 includes a band inner surface 202 and a band top end 203. Band inner surface 202 is the radially inner surface of outer band 201. In one embodiment, band inner surface 202 includes a draft between zero degrees and two degrees. In another embodiment, band inner surface 202 includes a one degree draft. In yet another embodiment, band inner surface 202 includes a draft from zero degrees to one degree. Other draft angles may also be used. Band top end 203 is the cylindrical end of outer band 201 distal to bottom plate 210.

Bottom ridge 218 may be adjacent and radially inward of bottom outer band slot 219. Bottom ridge 218 may be an annular shape and may be configured to form a tread sidewall of the tire. Bottom ridge 218 may also be adjacent bottom conical plate 220 and may be located between bottom outer band slot 219 and bottom conical plate 220.

FIG. 4 is a cross-sectional view of a portion of the mold bottom assembly 200 for the tire mold 100 of FIG. 1. In the embodiment illustrated, mold bottom assembly includes bottom conical plate 220, which is configured to form a conical sidewall 54 in the tire 50. In other embodiments, the bottom conical plate 220 is removed to form a straight sidewall 54 in the tire 50. Bottom conical plate 220 couples to bottom plate 210. Bottom conical plate 220 may be concentric to bottom plate 210 and may be located radially inward from bottom ridge 218.

Referring to FIGS. 2 and 4, bottom conical plate 220 may be a conical frustum with a bottom conical plate bore 222 extending there through. Bottom conical plate bore 222 may align with bottom plate bore 212. A bottom annular portion 226 and a bottom conical portion 221 may form the conical frustum shape. Bottom annular portion 226 may include a annular shape, such as a toroid or a hollow cylinder, forming bottom conical portion 221 with the bottom conical plate bore 222 extending there through. Bottom conical portion 221 may taper in the axial direction when moving radially outward from bottom annular portion 226. Bottom conical portion 221 includes a bottom conical surface 223. Bottom conical surface 223 is a conical surface configured to form a sidewall in a molded tire. Bottom conical surface 223 extends radially outward and axially toward bottom plate 210 from bottom annular portion 226 with a conical shape.

Bottom conical plate 220 may include bottom hydraulic cylinder slots 228. Bottom hydraulic cylinder slots 228 may be adjacent bottom conical plate bore 222 and distal to bottom plate 210. Bottom hydraulic cylinder slots 228 may be evenly spaced apart in the angular direction. Bottom hydraulic cylinder slots 228 are each configured to receive a bottom hydraulic cylinder 205. In the embodiment illustrated, bottom conical plate 220 includes six bottom hydraulic cylinder slots 228. Any number of bottom hydraulic cylinder slots 228 may be used.

Bottom conical plate 220 may also include bottom through holes 225. Bottom through holes 225 are configured and sized such that bottom cavity rods 240 may extend through bottom conical plate 220.

In the embodiment illustrated, bottom locating ring 230 is coupled to bottom conical plate 220. Bottom locating ring 230 may be coupled to bottom annular portion 226 adjacent bottom conical surface 223 and distal to bottom plate 210. Bottom locating ring 230 may be concentric to bottom conical plate 220. Bottom locating ring 230 may be an annular shape such as a toroid or hollow cylinder. Bottom locating ring 230 includes bottom locating ring outer surface 231, the radially outer surface of bottom locating ring 230. When rim 40 is inserted into mold bottom assembly 200, bottom locating ring 230 is configured to center rim 40 within mold bottom assembly 200 and is configured to form a seal with rim 40. Bottom locating ring 230 contacts rim 40 at first cylindrical end 41 with bottom locating ring outer surface 231 contacting first surface portion 43 to locate rim 40 within mold bottom assembly 200 and to form the seal between bottom locating ring 230 and rim 40.

Bottom locating ring 230 may include bottom locating ring fastening holes 235 for coupling bottom locating ring 230 to bottom conical plate 220 or to bottom plate 210 using bottom ring fasteners 236.

In the embodiment illustrated, bottom hydraulic cylinders 205 are coupled to bottom conical plate 220. Bottom hydraulic cylinders 205 may be inserted into a bottom hydraulic cylinder slot 228. In other embodiments, bottom hydraulic cylinders 205 are coupled to bottom plate 210. Bottom hydraulic cylinders 205 are configured to help remove rim 40 with the tire molded to the rim 40. Other mechanisms for removing the molded tire and rim 40 may also be used. Bottom hydraulic cylinders 205 may extend between bottom conical plate 220 and rim 40.

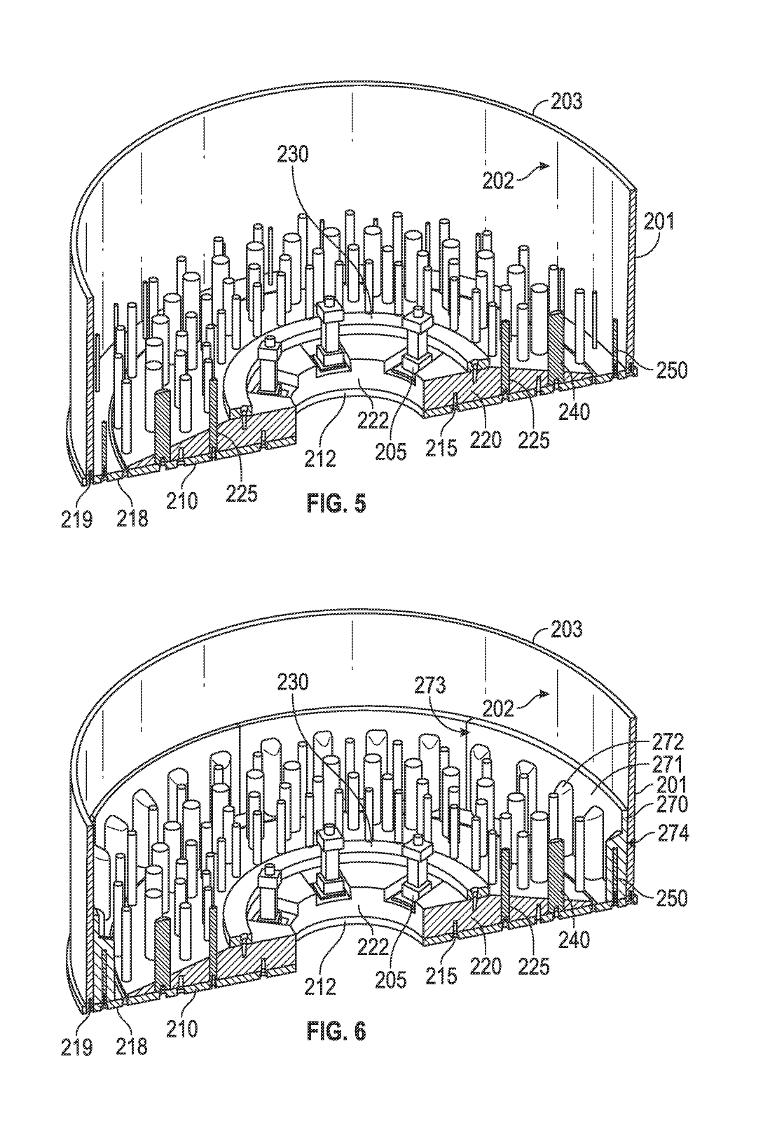

FIG. 5 is a cross-sectional view of a portion of the mold bottom assembly 200 for the tire mold 100 of FIG. 1. Bottom cavity rods 240 may couple to bottom plate 210 and extend in a first axial direction towards the top plate 310, beyond bottom conical surface 223. Bottom cavity rods 240 may be adjacent to bottom conical plate 220 or may extend through bottom through holes 225.

Bottom cavity rods 240 may be arranged in a predetermined pattern determined by the desired shape of the non-pneumatic tire. Bottom cavity rods 240 may be a bar/rod and may include, inter alia, a cylindrical shape, such as a right circular cylinder or an elliptical cylinder, or a prism shape, such as a cuboid. Mold bottom assembly 200 may include various sizes of bottom cavity rods 240. In one embodiment, bottom cavity rods 240 are sized with three different geometries and placed within mold bottom assembly 200. The lengths, thicknesses, diameters, etc. of bottom cavity rods 240 may be sized based on the desired shape of the non-pneumatic tire.

Bottom tread rods 250 may couple to bottom plate 210 adjacent to outer band 201 and adjacent the outer circumference of bottom plate 210. Bottom tread rods 250 may be evenly spaced apart in the angular direction forming a radial pattern. Bottom tread rods 250 may be a bar/rod and may include, inter alia, a cylindrical shape, such as a right circular cylinder or an elliptical cylinder, or a prism shape, such as a cuboid. In some embodiments, bottom tread rods 250 include a draft between zero degrees and two degrees. In another embodiment, bottom tread rods 250 include a one degree draft. In yet another embodiment, bottom tread rods 250 include a draft from zero degrees to one degree. In a further embodiment, bottom tread rods 250 includes a zero degree draft. Other draft angles may also be used.

FIG. 6 is a cross-sectional view of a portion of the mold bottom assembly 200 for the tire mold 100 of FIG. 1. As illustrated in FIG. 6, bottom tread inserts 270 are placed over bottom tread rods 250 adjoining outer band 201. Each bottom tread insert 270 may be configured to be placed over one or more bottom tread rods 250. In the embodiment illustrated, each bottom tread insert 270 covers four bottom tread rods 250.

Each bottom tread insert 270 may include a bottom radial wall 271 and one or more bottom tread forming features 272. Bottom radial wall 271 is an annular sector shape. All of the bottom radial walls 271 combine to form a hollow cylinder within outer band 201. When placed within mold bottom assembly 200, each bottom radial wall 271 extends up from bottom plate 210 along outer band 201. Each bottom radial wall 271 may extend up to approximately half the length of outer band 201. Bottom radial wall 271 includes a bottom radial molding surface 273 and a bottom radial outer surface 274. Bottom radial molding surface 273 faces radially inward and may be configured to form a portion of the outer radial surface of a tire. Bottom radial outer surface 274 faces radially outward and is contiguous to band inner surface 202. Bottom radial outer surface 274 may be drafted. The draft of bottom radial outer surface 274 may be the same or similar to the draft of band inner surface 202.

Each bottom tread forming feature 272 may be a protrusion (as illustrated) extending radially inward from bottom radial molding surface 273 or a depression extending radially outward from bottom radial molding surface 273 into bottom radial wall 271. In the embodiment illustrated, each bottom tread forming feature 272 aligns with a bottom tread rod 250. In other embodiments, bottom tread rods 250 may extend within bottom radial wall 271.

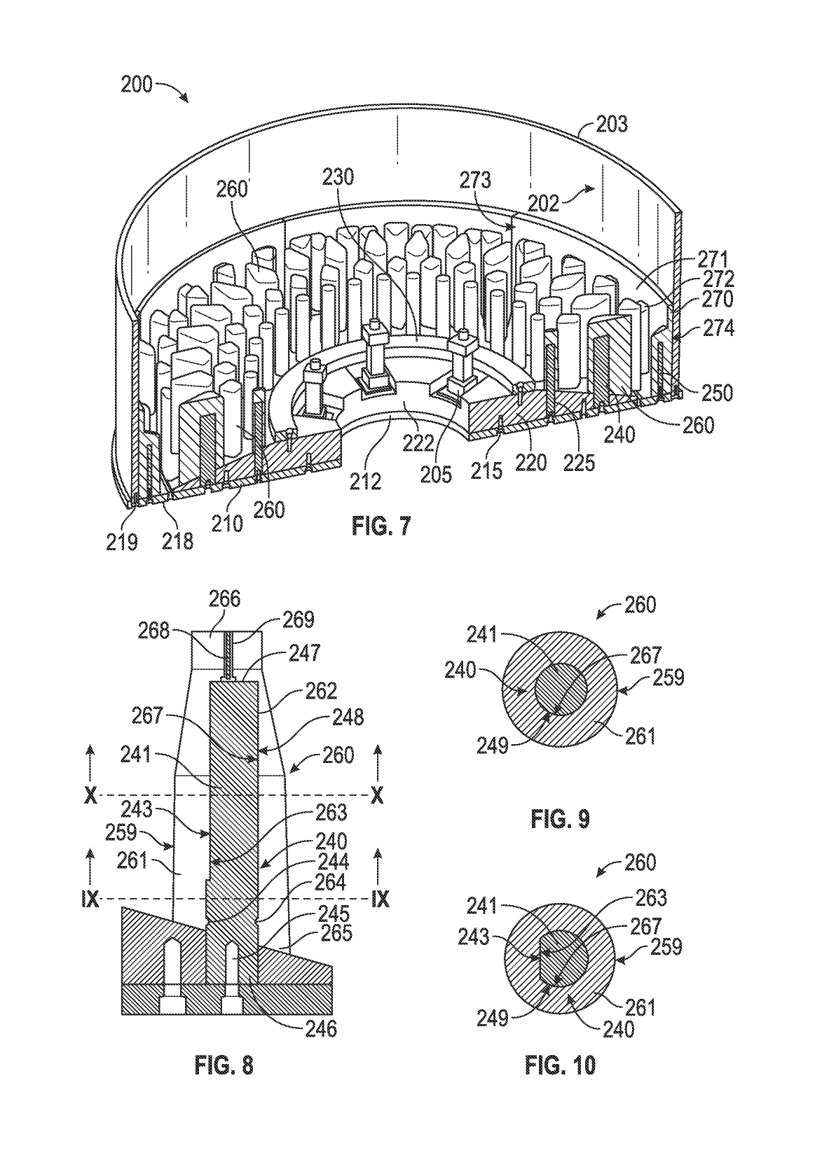

FIG. 7 is a cross-sectional view of the mold bottom assembly 200 for the tire mold 100 of FIG. 1. A bottom cavity insert 260 may be placed over each bottom cavity rod 240. Each bottom cavity insert 260 may be a solid that is an extruded plane geometrical shape, such as a cylinder, a regular prism, an irregular prism, or a combination of a cylinder and a prism. The solid may be extruded perpendicular to the plane geometric shape, such as a right cylinder, or a right prism.

Mold bottom assembly 200 may include various sizes and shapes of bottom cavity inserts 260 based on the desired shape of the non-pneumatic tire. In the embodiment illustrated, mold bottom assembly 200 includes four different shapes of bottom cavity inserts 260; the first shape being a wedge with a curved thick end, the curved thick end being a circular segment concentric to center axis 101 with the pointed end facing radially inward; the second shape being a right prism with a diamond shaped cross-section; the third shape being a right prism with a diamond shaped cross-section smaller than the cross-section of the second shape; and the fourth shape being a wedge, smaller than the first shape, with a curved thick end, the curved thick end being a circular segment concentric to center axis 101 with the pointed end facing radially outward.

Each set of shapes may be arranged to form a radial pattern. Bottom cavity inserts 260 with the first shape may be located nearest bottom tread inserts 270. The centroid of the bottom cavity inserts 260 with the second shape may be located radially inward and may be clocked relative to the centroid of the bottom cavity inserts 260 with the first shape. In the embodiment illustrated, the bottom cavity inserts 260 with the second shape may be clocked by one half the angular distance of two adjacent bottom cavity inserts 260 with the first shape. Bottom cavity inserts 260 with the third shape and the fourth shape may be similarly situated relative to bottom cavity inserts 260 with the second shape and the third shape respectively.

FIG. 8 is a cross-sectional view of a bottom cavity insert 260 assembled onto a bottom cavity rod 240 for the mold bottom assembly 200 of FIG. 7. Bottom cavity insert 260 may include a first end 265, a second end 266, a body 261, and an inner cavity 262. Second end 266 is distal to first end 265. Body 261 may be an elongated shape extending from first end 265 to second end 266.

FIG. 9 is a cross-sectional view of the bottom cavity insert 260 of FIG. 8 taken along the line IX-IX. Referring to FIGS. 8 and 9, body includes a body outer surface 259. All or a portion of body outer surface 259 may be tapered. The taper may be in the direction from first end 265 to second end 266. Inner cavity 262 extends within body 261 from the first end 265 towards the second end 266. Inner cavity 262 includes an inner cavity surface 267. Inner cavity surface 267 generally includes a corresponding shape to that of a bottom cavity rod 240 such that during mold assembly the insert 260 fits over, and is retained on the respective rod 240. In one embodiment, inner cavity surface 267 includes a cylindrical shape, such as a right circular cylinder or a right elliptical cylinder. In another embodiment, inner cavity surface 267 includes a prism shape, such as a cuboid. Inner cavity surface may be a zero draft surface.

FIG. 10 is a cross-sectional view of the bottom cavity insert of FIG. 8 taken along the line X-X. Referring to FIGS. 8 and 10, bottom cavity insert 260 may also include an insert orientation feature 263, an insert retaining feature 264, and an air hole 269. Insert orientation feature 263 is a clocking mechanism and is configured to set the orientation of bottom cavity insert 260 relative to bottom cavity rod 240. Insert orientation feature 263 may be located within inner cavity 262. Insert orientation feature 263 may extend completely or partially between first end 265 and second end 266, and may extend into inner cavity 262 from inner cavity surface 267 or may recede into body 261 from inner cavity surface 267. In the embodiment illustrated, insert orientation feature 263 is a flat surface disposed along the otherwise generally cylindrical inner cavity surface 267 and is located between insert retaining feature 264 and second end 266. Insert orientation feature 263 may also be a protrusion, a depression, a slot, a ridge, or a combination thereof. Insert orientation feature 263 interacts with a corresponding rod orientation feature 243 to assure that the bottom cavity insert 260 is correctly oriented relative to the bottom cavity rod 240 and to assure proper alignment of the bottom cavity insert 260 within the complex molding assembly.

Insert retaining feature 264 may also be located within inner cavity 262, at inner cavity surface 267, and proximal first end 265. Insert retaining feature 264 may be a rib extending into inner cavity 262 from inner cavity surface 267 or may be a depression extending into body 261 from inner cavity surface 267. Insert retaining feature 264 extends completely around inner cavity surface 267, such as an annular shape extending about a circumference of inner cavity surface 267. Insert retaining feature 264 may be located between first end 265 and insert orientation feature 263. Insert retaining feature 264 may help retain the bottom cavity inserts 260 on the bottom cavity rods 240 during demolding and when inverted. Insert retaining feature 264 corresponds to a rod retaining feature 244 and mates with the corresponding rod retaining feature 244 when bottom cavity insert 260 is inserted onto bottom cavity rod 240.

Bottom cavity insert 260 may also include an air hole 269 extending through body 261 from inner cavity 262 to second end 266. Air hole 269 may be a cylindrical shape. A pin 268 may be inserted with air hole 269 to prevent air from entering/leaving inner cavity 262 during the molding/demolding process and to prevent molding material from entering the bottom cavity insert 260. Pin 268 may be sized to plug air hole 269 and to prevent material from entering into inner cavity 262. A compressed air source may be coupled to air hole 269 to facilitate installation of bottom cavity insert 260 onto bottom cavity rod 240 or removal of bottom cavity insert 260 from bottom cavity rod 240. By using a compressed air source, the inner cavity 262 of bottom cavity insert 260, when made of a flexible material such as silicone can be caused to inflate or otherwise flex radially outwardly to facilitate the insertion of bottom cavity rod 240 and to allow the insert retaining feature 264 to pass over or into the corresponding rod retaining feature 244. This is especially important when inner cavity surface 267 and the rod outer surface 248 have a zero draft, where the draft angle is zero or within a predetermined tolerance of zero. The compressed air source may also be used to remove bottom cavity inserts 260 stuck in a tire sidewall cavity after the demolding process by injecting compressed air into the inner cavity 262. The pressure from the compressed air may help remove bottom cavity insert 260 from the sidewall cavity. Some of the compressed air may also be forced between the bottom cavity insert and the tire sidewall, which may reduce the friction between bottom cavity insert 260 and the tire sidewall.

Referring to FIGS. 8 and 9, bottom cavity rod 240 may include a rod first end 246, a rod second end 247 distal to the first rod end 246 and a rod body 241 extending there between. Bottom cavity rod 240 also includes a rod outer surface 248. As discussed above rod outer surface 248 may include a corresponding mating shape with the inner cavity surface 267 and may also include a zero draft surface.

Referring to FIGS. 8 and 10, bottom cavity rod 240 may include a rod orientation feature 243 and a rod retaining feature 244. Rod orientation feature 243 is a clocking mechanism and is configured to set the orientation of bottom cavity insert 260 relative to bottom cavity rod 240. Rod orientation feature 243 may extend completely or partially between first end 246 and second end 247, and may extend out from rod outer surface 248 or may recede into rod body 241 from rod outer surface 248. In the embodiment illustrated, rod orientation feature 243 is a flat surface disposed along the otherwise generally cylindrical rod outer surface 248 and is located between rod retention feature 244 and second end 247. Rod orientation feature 243 may also be a protrusion, a depression, a slot, a ridge, or a combination thereof. Rod orientation feature 243 and insert orientation feature 263 may interact to prevent relative rotation between bottom cavity rod 240 and bottom cavity insert 260.

Rod retaining feature 244 may be a rib extending out from rod outer surface 248 or may be a depression extending into rod body 211 from rod outer surface 248. Rod retaining feature 244 extends completely around rod outer surface 248, such as an annular shape extending about a circumference of rod outer surface 248. Rod retaining feature 244 may be located between rod first end 246 and rod orientation feature 243. Rod retaining feature 244 will be the negative of insert retaining feature 264. For example, if insert retaining feature 264 is a rib, then rod retaining feature 244 will be a depression sized to receive insert retaining feature 264. The interaction between insert retaining feature 264 and rod retaining feature 244 along with the zero drafts of inner cavity surface 267 and rod outer surface 248 may create suction between bottom cavity insert 260 and bottom cavity rod 240 so that bottom cavity insert 260 may be retained on bottom cavity rod 240 during demolding of a tire. Bottom cavity rods 240 may also include a rod fastening hole 245. Rod fastening hole 245 may be configured to receive a fastener, such as bottom fastener 216 to secure a bottom cavity rod 240 to bottom plate 210.

All of the features of mold bottom assembly 200, and in particular the features of bottom cavity inserts 260 and bottom cavity rods 240 described above may also be included and may correspond to features of mold top assembly 300, and in particular may correspond to features of top cavity inserts 360 and top cavity rods 360.

FIG. 11 is a cross-sectional view of a portion of the mold top assembly for the tire mold of FIG. 1. Top plate 310 may include all of the same or similar features as bottom plate 210. Top plate 310 is configured to sit on top of outer band 201 with band top end 203 abutting top plate 310. Referring to FIGS. 2 and 9, top plate 310 may include a top plate bore 312, vent holes 302, top fastening holes 315, a top outer band slot 319, and a top ridge 318. Top plate bore 312 may be concentric to top plate 310 and to center axis 101 when top plate 310 is assembled to tire mold 100. Top plate bore 310 may be aligned with bottom plate bore 210. Vent holes 302 extend through top plate 310 and may be used to vent material overflow out of the tire mold 100 and into overflow pans 110 or may be used to inject the molding material into the tire mold 100 through port 114. Port 114 may be coupled to one vent hole 302, while overflow pans 110 may be coupled to the remaining vent holes 302.

Top fastening holes 315 extend through top plate 310 and may be used for securing top conical plate 320 to top plate 310, top cavity rods 340 to top plate 310, and top tread rods 350 to top plate 310. Top fastening holes 315 may be selectively located to form a pattern, such as a radial pattern, with top cavity rods 340 and top tread rods 350. Top fastening holes 315 may be located radially outward from top plate bore 312. Top fasteners 316 may be used to secure top conical plate 320, top cavity rods 340, and top tread rods 350 to top plate 310.

Top outer band slot 319 may be adjacent the outer circumference of the top plate 310. Top outer band slot 319 may be located radially outward from top plate bore 312 and top fastening holes 315. Top outer band slot 319 may be an annular slot configured to receive the band top end 203. Outer band 201 may be inserted into top outer band slot 319 when joining mold top assembly 300 to mold bottom assembly 200.

Top ridge 318 may be adjacent and radially inward of top outer band slot 319. Top ridge 318 may be an annular ridge and may be configured to form a tread sidewall of the tire. Top ridge 318 may also be adjacent top conical plate 320 and may be located between top outer band slot 319 and top conical plate 320.

In the embodiment illustrated, mold top assembly 300 includes top conical plate 320, which is configured to form a conical sidewall in the tire. In other embodiments, the top conical plate 320 is removed to form a straight sidewall in the tire. Top conical plate 320 couples to top plate 310. Top conical plate 320 may be concentric to top plate 310 and may be located radially inward from top ridge 318.

Top conical plate 320 may include all of the same or similar features as bottom conical plate 220. Top conical plate 320 may be a conical frustum with a top conical plate bore 322 extending there through. Top conical plate bore 322 may align with top plate bore 312. A top annular portion 326 and a top conical portion 321 may form the conical frustum shape. Top annular portion 326 may include an annular shape, such as a toroid or a hollow cylinder, forming top conical portion 321. Top conical portion 321 may taper in the axial direction when moving radially outward from top annular portion 326. Top conical portion 321 includes a top conical surface 323. Top conical surface 323 is a conical surface configured to form a sidewall in a molded tire. Top conical surface 323 extends radially outward and axially toward top plate 310 from top annular portion 326 with a conical shape. The combination of the bottom conical surface 223 and the top conical surface 323 may form a tire that includes a trapezoidal cross-section.

Top conical plate 320 may include top hydraulic cylinder slots 328. Top hydraulic cylinder slots 328 may be adjacent top conical plate bore 322 and distal to top plate 310. Top hydraulic cylinder slots 328 may be evenly spaced apart in the angular direction. Top hydraulic cylinder slots 328 are each configured to receive a top hydraulic cylinder 305. In the embodiment illustrated, top conical plate 320 includes six top hydraulic cylinder slots 328. Any number of top hydraulic cylinder slots 328 may be used.

Top conical plate 320 may also include top through holes 325. Top through holes 325 are configured and sized such that top cavity rods 340 may extend through top conical plate 320.

Top locating ring 330 may include all of the same or similar features as bottom locating ring 230. In the embodiment illustrated, top locating ring 330 is coupled to top conical plate 320. Top locating ring 330 may be concentric to top conical plate 320. Top locating ring 330 may be coupled to top annular portion 326 adjacent top conical surface 323. Top locating ring 330 may be an annular shape such as a toroid or hollow cylinder. Top locating ring 330 includes top locating ring outer surface 331, the radially outer surface of top locating ring 330. When tire mold 100 is assembled with a rim 40 inserted, Top locating ring 330 contacts rim 40 at second cylindrical end 42 with top locating ring outer surface 331 contacting second surface portion 44 to align rim 40 with mold top assembly 300 and to form a seal with rim 40.

Top locating ring 330 may include top locating ring fastening holes 335 for coupling top locating ring 330 to top conical plate 320 or to top plate 310 using top ring fasteners 336.

In the embodiment illustrated, top hydraulic cylinders 305 are coupled to top conical plate 320. Top hydraulic cylinders 305 may be inserted into a top hydraulic cylinder slot 328. In other embodiments, top hydraulic cylinders 305 are coupled to top plate 310. Top hydraulic cylinders 305 are configured to help separate mold top assembly 300 from rim 40 and the tire molded to the rim 40. Other mechanisms for separating mold top assembly 300 from the molded tire and rim 40 may also be used. Top hydraulic cylinders 305 may extend between top conical plate 320 and rim 40.

Top cavity rods 340 may include all of the same or similar features as bottom cavity rods 240 disclosed above. Top cavity rods 340 may couple to top plate 310 and extend in a second axial direction towards the bottom plate 210, beyond top conical surface 323. Top cavity rods 340 may be adjacent to top conical plate 320 or may extend through top through holes 325.

Top cavity rods 340 may be arranged in a predetermined pattern determined by the desired shape of the non-pneumatic tire. Top cavity rods 340 may be a bar/rod and may include, inter alia, a cylindrical shape, such as a right circular cylinder or an elliptical cylinder, or a prism shape, such as a cuboid. Mold top assembly 300 may include various sizes of top cavity rods 340. In one embodiment, top cavity rods 340 are sized with three different geometries and placed within mold top assembly 300. The lengths, thicknesses, diameters, etc. of top cavity rods 340 may be sized based on the desired shape of the non-pneumatic tire. Each top cavity rod 340 may include a rod orientation feature 243, a rod retaining feature 244, and a rod fastening hole 245 as described in reference to FIGS. 8-10.

Top tread rods 350 may include all of the same or similar features as bottom tread rods 250. Top tread rods 350 may couple to top plate 310 adjacent to top outer band slot 319 and adjacent the outer circumference of top plate 310. Top tread rods 350 may be evenly spaced apart in the angular direction forming a radial pattern. Top tread rods 350 may be a bar/rod and may include, inter alia, a cylindrical shape, such as a right circular cylinder or an elliptical cylinder, or a prism shape, such as a cuboid. In some embodiments, top tread rods 350 include a draft between zero degrees and two degrees. In another embodiment, top tread rods 350 include a one degree draft. In yet another embodiment, top tread rods 350 include a draft from zero degrees to one degree. In a further embodiment, top tread rods 350 includes a zero degree draft. Other draft angles may also be used.

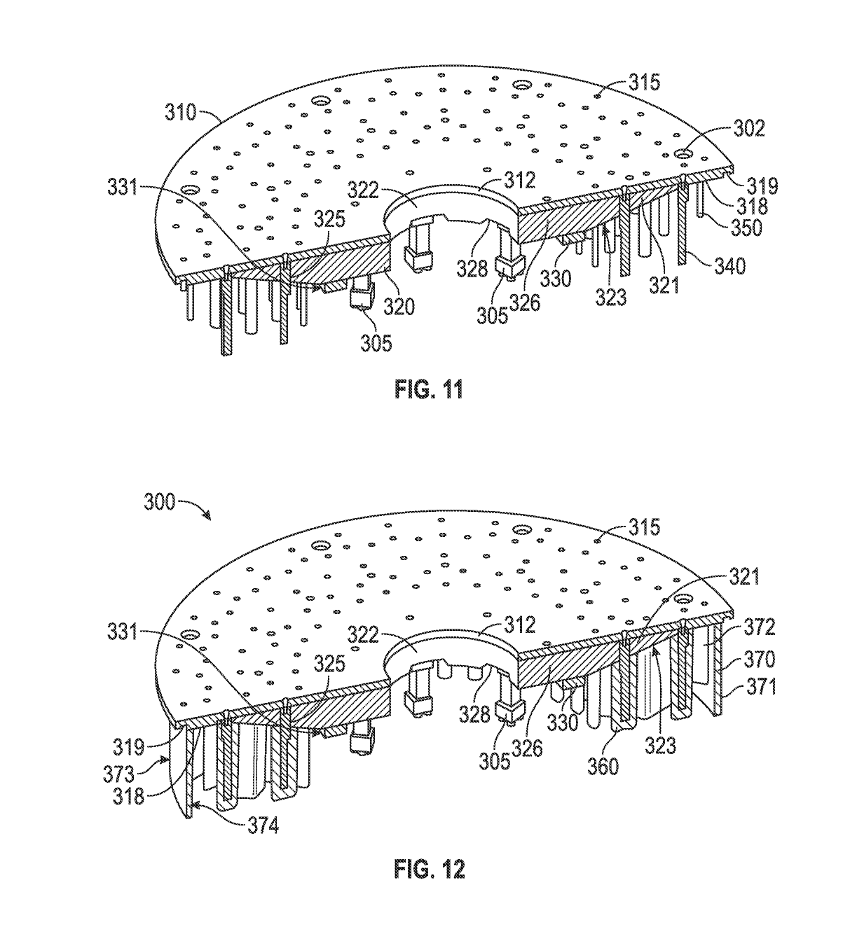

FIG. 12 is a cross-sectional view of the mold top assembly 300 for the tire mold of FIG. 1.

Top tread inserts 370 may include all of the same or similar features as bottom tread inserts 270. Top tread inserts 370 are placed over top tread rods 350 and are configured to adjoin outer band 201 when mold top assembly 300 is joined to mold bottom assembly 200. Each top tread insert 370 may be configured to be placed over one or more top tread rods 350. In the embodiment illustrated, each top tread insert 370 covers four top tread rods 350.

Each top tread insert 370 may include a top radial wall 371 and one or more top tread forming features 372. Top radial wall 371 is an annular sector. All of the top radial walls 371 combine to form a hollow cylinder. When mold top assembly 300 is joined to mold bottom assembly 200, each top radial wall 371 extends down from top plate 310 along outer band 201. Each top radial wall 371 may extend down to approximately half the length of outer band 201 and may be configured to abut with a bottom radial wall 271. Top radial wall 371 includes a top radial molding surface 373 and a top radial outer surface 374. Top radial molding surface 373 faces radially inward and may be configured to form a portion of the outer radial surface of a tire. Top radial outer surface 374 faces radially outward and is contiguous to band inner surface 202 when mold top assembly 300 is joined to mold bottom assembly 200. Top radial outer surface 374 may be drafted. The draft of top radial outer surface 374 may be the same or similar to the draft of band inner surface 202.

Each top tread forming feature 372 may be a protrusion (as illustrated) extending radially inward from top radial molding surface 373 or a depression extending radially outward from top radial molding surface 373 into top radial wall 371. In the embodiment illustrated, each top tread forming feature 372 aligns with a top tread rod 350. In other embodiments, top tread rods 350 may extend within top radial wall 371.

Top cavity inserts 360 may include all of the same or similar features as bottom cavity inserts 260. A top cavity insert 360 may be placed over each top cavity rod 340. Each top cavity insert 360 may be a solid that is an extruded plane geometrical shape, such as a cylinder, a regular prism, an irregular prism, or a combination of a cylinder and a prism. The solid may be extruded perpendicular to the plane geometric shape, such as a right cylinder, or a right prism.

Mold top assembly 300 may include various sizes and shapes of top cavity inserts 360 based on the desired shape of the non-pneumatic tire 50. In the embodiment illustrated, mold top assembly 300 includes four different shapes of top cavity inserts 360, the same shapes for the bottom cavity inserts 260 in the embodiment described above. Each set of shapes may be arranged to form a radial pattern, such as in the radial pattern described in the embodiment above.

Each top cavity insert 360 may include a first end 265, a second end 266, an inner cavity 262, an insert orientation feature 263, an insert retaining feature 264, and an air hole 269 as described in reference to FIG. 8-10 above. A pin 268 may be inserted into the air hole 269 of each top cavity insert 360.

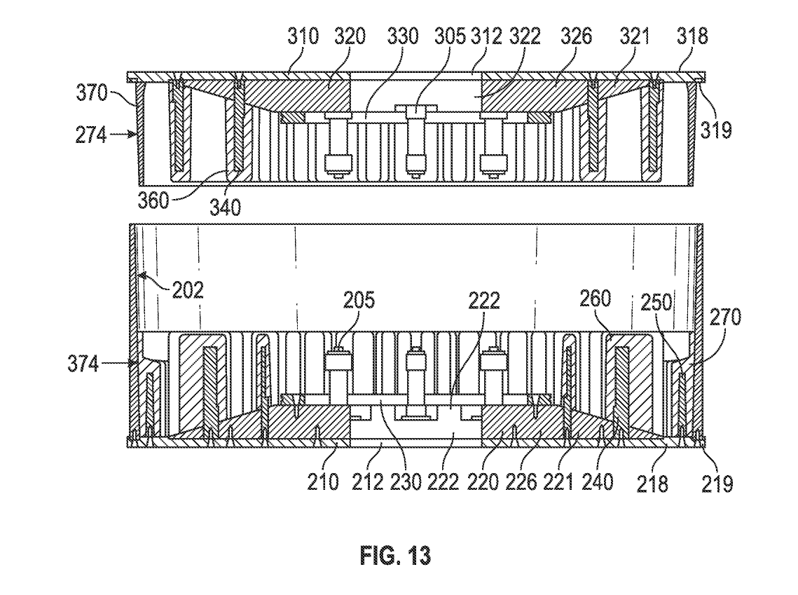

FIG. 13 is a cross-sectional view of the tire mold 100 of FIG. 1 with the mold top assembly 300 removed from the mold bottom assembly 200. As illustrated in FIG. 13, outer band 201 and top tread inserts 370, and in particular the interaction between band inner surface 202 and top radial outer surface 374 may guide mold top assembly 300 and mold bottom assembly 200 together. The interaction between band inner surface 202 and top radial outer surface 374 may also guide outer band 201 into top outer band slot 319. The drafts/tapers on band inner surface 202 and top radial outer surface 374 may further facilitate the assembly/disassembly of tire mold 100.

Referring to FIG. 2, mold bottom assembly 200, mold top assembly 300, and rim 40 form a sealed interior configured to receive a molding material.

One or more of the above components (or their subcomponents), such as bottom plate 210, top plate 310, bottom conical plate 220, top conical plate 320, bottom locating ring 230, top locating ring 330, bottom cavity rods 240, top cavity rods 340, bottom tread rods 250, top tread rods 350, and outer band 201, may be made from a material with high thermal conductivity, such as aluminum, which may provide good heat transfer to and from the molding material during curing and cooling.

Other components (or their subcomponents), such as bottom cavity inserts 260, top cavity inserts 360, bottom tread inserts 270, and top tread inserts 370, may be made from a heat-resistant material that is relatively easy to separate from the molding material of tire 50 following curing of the molding material, such as silicon or a similar material. For example, the material forming bottom cavity inserts 260, top cavity inserts 360, bottom tread inserts 270, and top tread inserts 370 may be capable of being heated above the curing temperature of a urethane and/or rubber molding material during curing of the molding material so that bottom cavity inserts 260, top cavity inserts 360, bottom tread inserts 270, and top tread inserts 370 maintain their desired shape during the curing process.

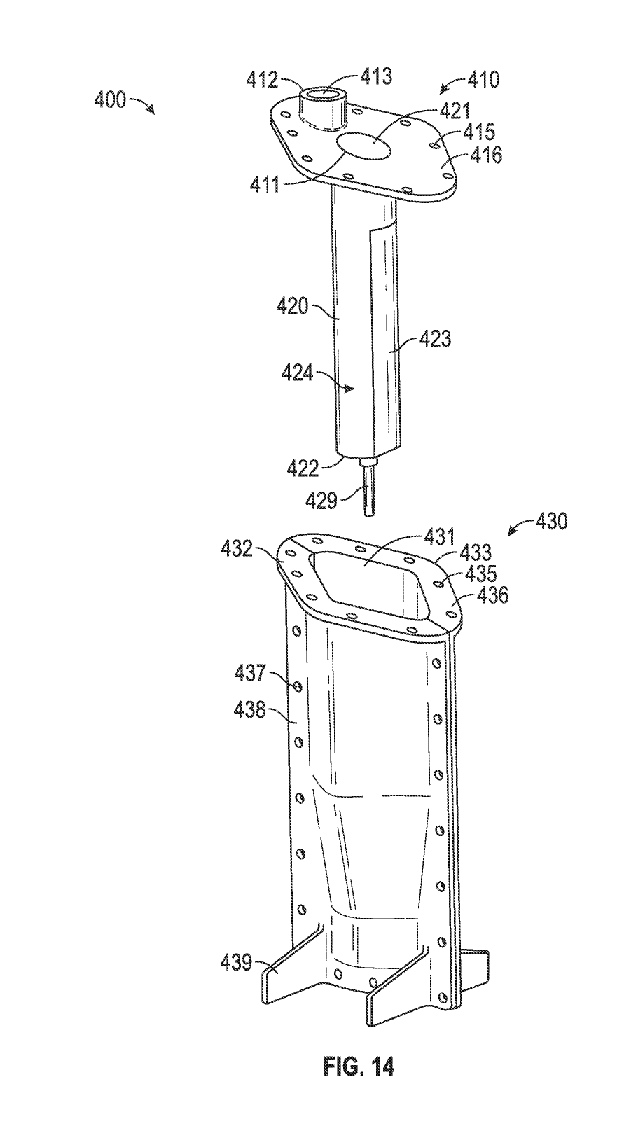

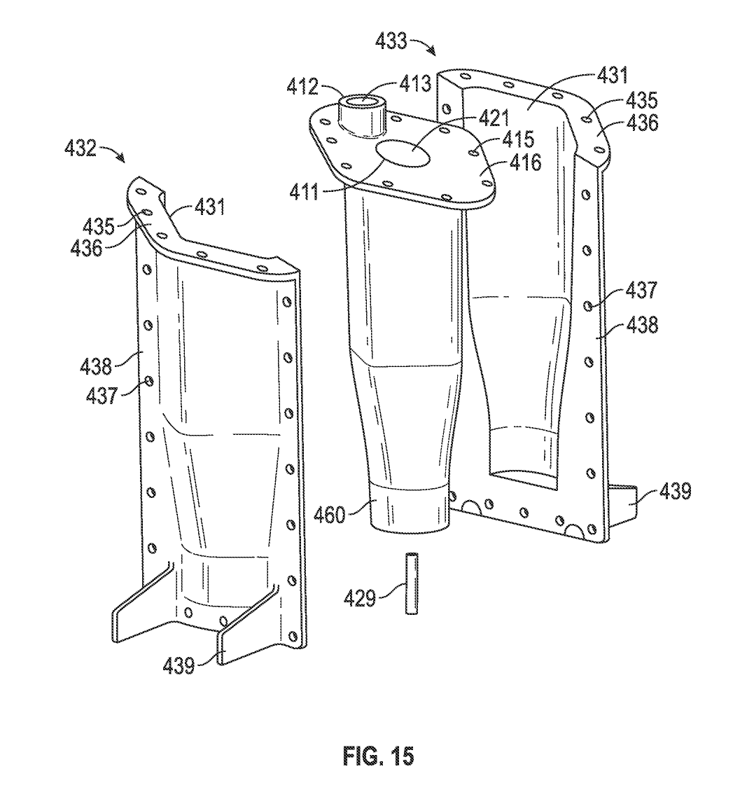

FIG. 14 is perspective view of a rapid prototype tooling 400 for molding an insert 460 for the tire mold 100 of FIG. 1 with the top portion 410 removed. FIG. 15 is a perspective view of the rapid prototype tooling 400 of FIG. 14 partially demolded. Insert 460 may be at least one of the bottom cavity inserts 260, the top cavity inserts 360, the bottom tread inserts 270, and/or the top tread inserts 370.

Referring to FIGS. 12 and 13, rapid prototype tooling 400 includes top portion 410, a clamshell portion 430, and a dowel 429. Top portion 410 includes top cover 416, a fill port 412, and one or more cores 420. Top cover 416 may be a plate and may be shaped to form a seal with clamshell portion 430. Top cover 416 may include a cover hole 411 and may include cover fastening holes 415 for fastening top cover 416 to clamshell portion 430. Fill port 412 may be a flange extending up from top cover 416 in the direction opposite clamshell portion 430.

Core 420 extends from top cover 416 in the direction opposite fill port 412 and is configured to extend within clamshell portion 430 when the top portion 410 is joined to the clamshell portion 430. Core 420 may include a cylindrical shape or a prism shape. In one embodiment, top portion 410 includes one core 420. In another embodiment, top portion 410 includes two cores 420. In yet another embodiment, top portion 410 includes three cores 420. In a further embodiment, top portion 410 includes four cores 420.

Core 420 may include a core hole 421 and a core orientation feature 423. Core hole 421 may be a blind hole extending from cover hole 411 down through core 420 to the core end 422 distal to top cover 416. Core orientation feature 423 is configured to form an orientation feature within insert 460 (shown in FIG. 14), such as insert orientation feature 263. In the embodiment illustrated, core orientation feature 423 is a flat surface.

Core 420 may also include a core surface 424. Core surface 424 may be all or a portion of a cylindrical surface or the surface of a prism. In some embodiments, core surface 424 is a zero draft surface. In other embodiments, core surface 424 is drafted from zero degrees to two degrees. In another embodiment, core surface 424 is drafted at an angle greater than zero degrees and up to one degree.

Clamshell portion 430 includes a first clamshell 432 and a second clamshell 433 that are joined together to form a clamshell cavity 431. First clamshell 432 and second clamshell 433 each include a top flange 436 and a clamshell flange 438. Top flange 436 is configured to be joined with top cover 416. Top flange 436 includes top flange holes 435 configured to align with cover fastening holes 415. Clamshell flanges 438 extends down the sides and across the bottom of first clamshell 432 and second clamshell 433 around a portion of clamshell cavity 431 and are configured to align together. Each clamshell flange 438 includes clamshell flange holes 437 that are configured to secure first clamshell 432 to second clamshell 433.

Clamshell portion 430 may also include stands 439 extending out at the base 434 of clamshell portion 430, opposite clamshell flange 438.Stands 439 are configured to stabilize rapid prototype tooling 400 and prevent rapid prototype tooling 400 from falling over.

During assembly of rapid prototype tooling 400, first clamshell 432 is coupled to second clamshell 433, a dowel 429 is affixed to each core end 422, and top portion 410 is coupled to clamshell portion 430 with the core(s) 420 and the dowel(s) 429 located within the clamshell portion 430. Dowel 429 may be affixed to core end 422 with an adhesive, such as clay. After forming insert 460, the dowel 429 may be used as pin 268 in the tire mold 100.

Top portion 410, first clamshell 432, and second clamshell 433 may each be a single integral piece. Top portion 410, first clamshell 432, and second clamshell 433 may each be formed by a rapid prototyping method, such as additive manufacturing. Top portion 410, first clamshell 432, and second clamshell 433 may be made from rapid prototyping materials. The rapid prototyping materials may be plastic including thermoplastics, such as acrylonitrile butadiene styrene (ABS), polycarbonate, static dissipative plastics, or flame resistant plastics. The rapid prototyping materials may also be hard or soft resins, such as polypropylene or photopolymers, The rapid prototyping materials may be either thermally deposited or laser cured.

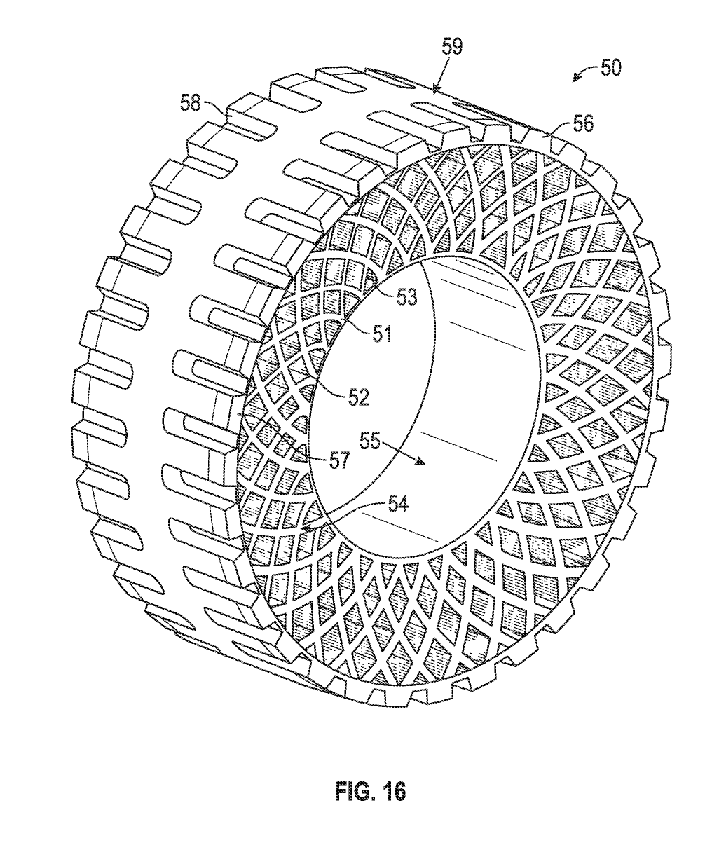

FIG. 16 is an exemplary tire 50 molded with the tire mold 100 of FIG. 1. Tire 50 includes a support structure 51 and a tread portion 56. Support structure 51 may include a toroidal shape. The cross-section revolved about the tire axis to form the toroidal shape may be a trapezoid or a rectangle. Support structure 51 may include structural members 53 arranged in a geometric pattern forming cavities 52 within support structure 51. Cavities 52 may be configured to extend through support structure 51 in the axial direction. Cavities 52 may extend partially through support structure 51 or may extend completely through support structure 51.

Support structure 51 also includes an inner tire surface 55 and a sidewalls 54. Inner tire surface 55 is a cylindrical surface and is configured to interface with rim 40. Tire 50 and rim 40 are combined to form a wheel for a machine. Sidewalls 54 are the radial surfaces of support structure 51 extending between tread portion 56 and inner tire surface 55. In some embodiments, sidewalls 54 are angled inward so that the thickness of tire 50 at tread portion 56 is greater than the thickness of tire 50 at inner tire surface 55, forming the trapezoidal shape. In other embodiments, sidewalls 54 are perpendicular to the axis of tire 50.

Support structure 51 including structural members 53, cavities 52, and the angle of sidewalls 54 may be configured to provide a desired amount of cushioning between a machine and the terrain. Support structure 51 may also be configured to support the machine in a loaded, partially loaded, and empty condition, such that a desired amount of cushioning is provided, regardless of the load.

Tread portion 56 is located radially outward from support structure 51. Tread portion 56 may include an annular shape, such as a toroid with a rectangular cross-section revolved about the tire axis. Tread portion 56 includes an outer tire surface 59, tread sidewalls 57, and treads 58. Outer tire surface 59 is a cylindrical surface concentric to inner tire surface 55. Tread sidewalls 57 may be annular surfaces on each side of tire 50 extending radially inward from outer tire surface 59 to a sidewall 54.

Treads 58 may be depressions extending into tread portion 56 from outer tire surface 59 or may be protrusions extending outward from outer tire surface 59. In the embodiment illustrated, treads 58 are depressions that extend partially across outer tire surface 59 from a sidewall 54. In other embodiments, treads 58 are depressions that do not extend to either sidewall 54. Tread portion 56, and in particular treads 58 may be configured to provide a desired amount of traction for a machine regardless of load.

Tire 50 may have dimensions tailored to the desired performance characteristics based on the expected use of the tire 50. For example, exemplary tire 50 may have a width (W) at tread portion 56 ranging from 0.1 meter to 2 meters (e.g., 1 meter), an inner diameter for coupling with rim 40 ranging from 0.5 meter to 4 meters (e.g., 2 meters), and an outer diameter ranging from 0.75 meter to 6 meters (e.g., 4 meters). According to some embodiments, the ratio of the inner diameter of tire 50 to the outer diameter of tire 50 ranges from 0.25:1 to 05:1, or 0.4:1 to 0.6:1, for example, about 0.5:1. Support structure 51 may have an inner axial width at inner tire surface 55 ranging from 0.05 meter to 3 meters (e.g., 0.8 meter), and an outer axial width adjoining tread portion 56 ranging from 0.1 meter to 2 meters (e.g., 1 meter). Other dimensions are contemplated. For example, for smaller machines, correspondingly smaller dimensions are contemplated.

Tire 50 may be made from an elastically deformable material, such as, polyurethane, natural rubber, urethane, and/or synthetic rubber.

### INDUSTRIAL APPLICABILITY

The systems and methods for molding parts disclosed herein may be used to mold non-pneumatic tires 50 for the wheels of a machine configured to travel across terrain. For example, such wheels may be used on machines, such as, for example, an automobile, a truck, an agricultural vehicle, and/or a construction vehicle, such as, for example, a wheel loader, a dozer, a skid-steer loader, an excavator, a grader, an on-highway truck, an off-highway truck, and/or any other vehicle type known to a person skilled in the art. In addition to being used on self-propelled machines, the wheels may be used on any device configured to travel across terrain via assistance or propulsion from another machine.

According to some embodiments of the systems and methods, it may be possible to form relatively small or intricate features, such as cavities 52 and treads 58, in the parts being molded, while facilitating separation of portions of the mold from the molded parts following curing of the molding material inside the mold. According to some embodiments, the systems and methods may be used to form features in the parts that extend relatively deeply into the molded parts, even if the molded part is particularly large. As a result, it may not be necessary to design the mold so that it has relatively large draft angles to facilitate removal of the molded parts from the mold following curing of the molding material.

The materials of the inserts 460, such as bottom cavity inserts 260, top cavity inserts 360, bottom tread inserts 270, and top tread inserts 370, such as silicon may not naturally stick to the materials of tire 50, such as urethane, which may facilitate the removal of the sleeves. Bottom cavity inserts 260 and top cavity inserts 360 may elongate during demolding, which may cause the cross-section to shrink, further facilitating demolding. The zero draft surfaces on bottom cavity inserts 260, top cavity inserts 360, bottom cavity rods 240, and top cavity rods 340 may form a vacuum that holds bottom cavity inserts 260 on bottom cavity rods 240, and top cavity inserts 360 on top cavity rods 340. Rod retaining features 244 and insert retaining features, such as ribs and grooves may further hold bottom cavity inserts 260 on bottom cavity rods 240 and top cavity inserts 360 on top cavity rods 340.

Bottom tread inserts 270 and top tread inserts 370 may be configured to demold radially from tire 50. Top tread inserts 370 may remain in place adjacent tire 50 when mold top assembly 300 is removed from mold bottom assembly 200 during the demolding process. Bottom tread inserts 270 may separate from the remainder of mold bottom assembly 200 as tire 50 is removed from mold bottom assembly 200. As top tread inserts 370 and bottom tread inserts 270 are lifted above outer band 201 they may be radially separated from tire 50. Some of the top tread inserts 370 and the bottom tread inserts 270 may fall out without the radial support of outer band 201, while others may be removed by applying an outer radial force. The drafts on band inner surface 202, bottom radial outer surface 274, and top radial outer surface 374 may facilitate the removal of bottom tread inserts 270 and top tread inserts 370 with tire 50 from within mold bottom assembly 200 during the demolding process.

Radial removal of bottom tread inserts 270 and top tread inserts 370 may facilitate the use of a variety of tread designs. In particular, the treads 58 may not need to extend to one of the tread sidewalls 57, which may be a constraint in an axially demolded tread forming process.

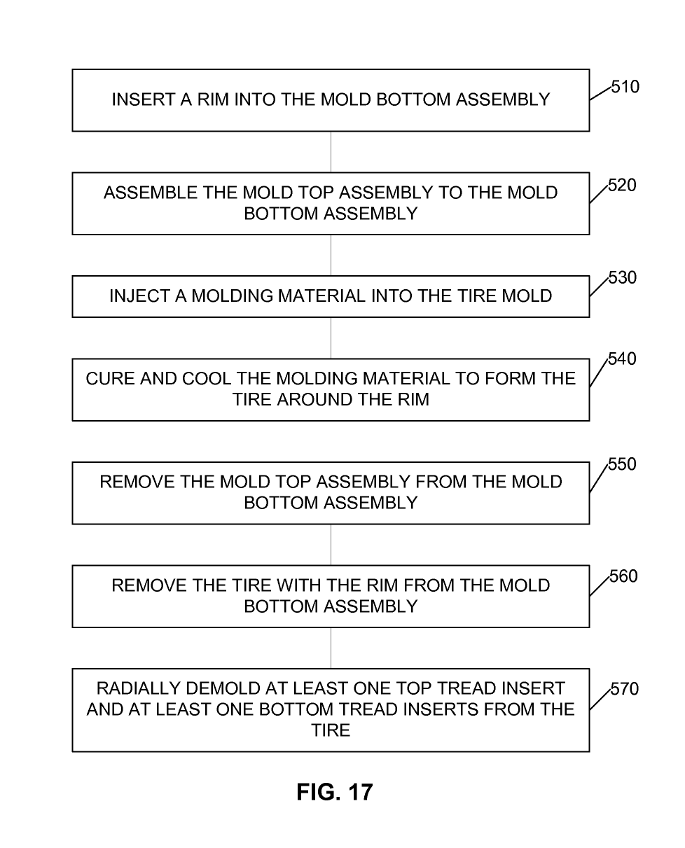

FIG. 17 is a flowchart of a method for molding a non-pneumatic tire 50 using the tire mold 100. The method includes inserting a rim 40 into a mold bottom assembly 200 at step 510. The rim 40 is inserted so that the first cylindrical end 41 of the rim 40 is located radially outward from and contacts the bottom locating ring 230 to center the rim in the mold bottom assembly 200. The contact between the first cylindrical end 41 and bottom locating ring 230 forms a seal between rim 40 and bottom locating ring 230.

Step 510 is followed by assembling the mold top assembly 300 to the mold bottom assembly 200 at step 520. The top tread inserts 370 may be used as guides to align mold top assembly 300 with mold bottom assembly 200 as top tread inserts 370 are lowered into outer band 201. The method may include lowering the top locating ring 330 into the rim 40 so that the second cylindrical end 42 of the rim 40 is located radially outward and contacts the top locating ring 330 to align the mold top assembly 300 with the mold bottom assembly 200. The contact between the second cylindrical end 42 and the top locating ring 330 forms a seal between rim 40 and top locating ring 330. The method may also include inserting band top end 203 into top outer band slot 319 to align mold top assembly 300 with mold bottom assembly 200.

Step 520 is followed by injecting a molding material into the tire mold 100 at step 530. Step 530 is followed by curing and cooling the molding material to form the tire 50 around rim 40 at step 540.

Step 540 is followed by removing the mold top assembly 300 from mold bottom assembly 200 at step 550. While removing mold top assembly 300 from mold bottom assembly 200, at least one of the top cavity inserts 360 should remain coupled to one or more of the top cavity rods 340; and at least one of the top tread inserts 370 should decouple from one or more of the top tread rods 350 and remain between the tire 50 and the outer band 201. Top hydraulic cylinders 305 may be used to help separate mold top assembly 300 from tire 50 and mold bottom assembly 200.

Step 550 is also followed by removing tire 50 with rim 40 from mold bottom assembly 200 at step 560. While removing tire 50 with rim 40 from mold bottom assembly 200, at least one of the bottom cavity inserts 260 should remain coupled to one or more of the bottom cavity rods 240; and at least one of the bottom tread inserts 270 should decouple from one or more of the bottom tread rods 250. Bottom hydraulic cylinders 205 may be used to help separate tire 50 with rim 40 from mold bottom assembly 200.

Step 550 is also followed by radially demolding one or more top tread inserts 370 and one or more bottom tread inserts 270 from tire 50 at step 570. Radially demolding the one or more top tread inserts 370 and the one or more bottom tread inserts 270 may occur simultaneously with removing tire 50 with rim 40 from mold bottom assembly 200 and/or after removing tire 50 with rim 40 from mold bottom assembly 200.

After removing tire 50 with rim 40 from mold bottom assembly 200, some top cavity inserts 360 and/or some bottom cavity inserts 260 may remain within cavities 52. Any remaining top cavity inserts 360 and bottom cavity inserts 260 may be removed using compressed air. The compressed air may be supplied through the air hole 269.

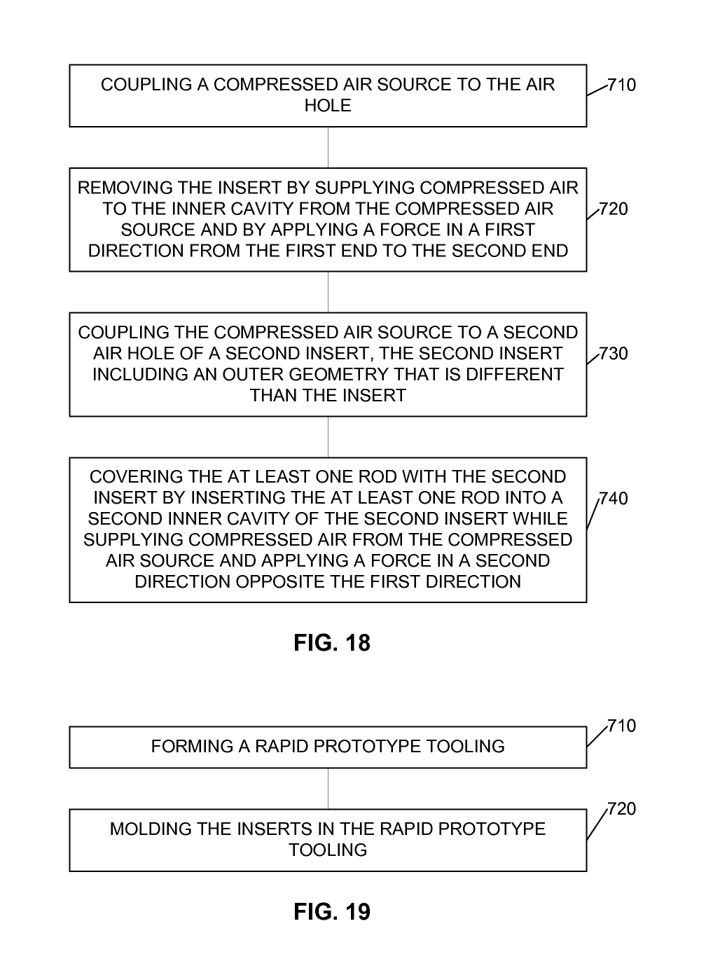

FIG. 18 is a flowchart of a method for modifying the tire mold of FIGS. 1-11. The method includes coupling a compressed air source to the air hole 269 at step 610. The method also includes removing an insert, such as bottom cavity insert 260 or top cavity insert 360, by supplying compressed air to the inner cavity 262 from the compressed air source and by applying a force in a first direction from the first end 265 to the second end 266 at step 620. The zero draft surfaces of the inner cavity surface 267 and the rod outer surface 248 along with the insert retaining feature 264 and the rod retaining feature 244 may create a suction when trying to remove the insert. Supplying compressed air to the inner cavity 262 may create a buffer of air between all or portions of inner cavity surface 267 and rod outer surface 248 and allow the insert to be removed with less force and effort.

The method further includes coupling the compressed air source to a second air hole 269 of a second insert, the second insert including an outer geometry that is different than the insert at step 630. The method yet further includes covering the at least one rod with the second insert by inserting the at least one rod into a second inner cavity of the second insert while supplying compressed air from the compressed air source and applying a force in a second direction opposite the first direction at step 640. The removal of inserts and replacement of inserts with different geometry may allow a tire mold 100 to be quickly adapted and the design of the tire 50 to be modified without having to create an entirely new mold. Instead, the inserts are swapped out to change the cavity geometries and thereby modifying the material and physical characteristics of the molded tire 50.

In some embodiments, inserts 460 such as bottom cavity inserts 260, top cavity inserts 360, bottom tread inserts 270, and top tread inserts 370 may be formed prior to being placed over bottom cavity rods 240, top cavity rods 340, bottom tread rods 250, and top tread rods 350 respectively. FIG. 19 is a flowchart of a method for forming inserts 460. The method includes forming a rapid prototype tooling 400 at step 710. The rapid prototype tooling 400 may be generated using a rapid prototyping method, such as additive manufacturing. Step 710 is followed by molding the inserts 460 in the rapid prototype tooling 400 at step 720. The inserts 460 may be removed from the rapid prototype tooling 400 using compressed air.

The geometry of tire 50 and in particular structural members 53, cavities 52, and treads 58 may be modified by removing and replacing the inserts 460, such as bottom cavity inserts 260, top cavity inserts 360, bottom tread inserts 270, and top tread inserts 370 from bottom cavity rods 240, top cavity rods 340, bottom tread rods 250, and top tread rods 350 respectively. In some embodiments, removal and replacement of inserts 460 may be facilitated by removing pin 268 from air hole 269 and supplying compressed air into inner cavity 262 through air hole 269.

A new radial pattern for tire 50 may be quickly and relatively inexpensively be generated using the rapid prototype tooling 400 to form inserts 460 with different shapes to replace the previous inserts 460. The radial pattern for tire 50 may also be modified by changing the locations and the number of bottom cavity rods 240, top cavity rods 340, bottom tread rods 250, and top tread rods 350, and consequently the locations and number of bottom cavity inserts 260, top cavity inserts 360, bottom tread inserts 270, and top tread inserts 370.

The preceding detailed description is merely exemplary in nature and is not intended to limit the invention or the application and uses of the invention. The described embodiments are not limited to use in conjunction with a particular type of system or method for molding parts, such as tires. Hence, although the present disclosure, for convenience of explanation, depicts and describes a particular tire mold and a particular rapid prototype tooling, it will be appreciated that the tire mold and rapid prototype tooling in accordance with this disclosure can be implemented in various other configurations, and can be used with various other types of systems for molding parts. Furthermore, there is no intention to be bound by any theory presented in the preceding background or detailed description. It is also understood that the illustrations may include exaggerated dimensions to better illustrate the referenced items shown, and are not consider limiting unless expressly stated as such.

What is claimed is:

1. A removable insert for a tire mold used to manufacture a non-pneumatic tire, the removable insert comprising:
a first end;
a second end distal to the first end;
a body extending between the first end and the second end;
an inner cavity extending within the body from the first end towards the second end, the inner cavity including
an inner cavity surface; and
an insert retaining feature located at inner cavity surface proximal the first end.

2. The removable insert of claim 1, wherein the insert retaining feature extends completely around inner cavity surface.

3. The removable insert of claim 2, wherein the insert retaining feature is an annular rib extending into the inner cavity from the inner cavity surface.

4. The removable insert of claim 1, further comprising an insert orientation feature extending between the first end and the second end within the inner cavity.

5. The removable insert of claim 4, wherein the insert orientation feature is a flat surface.

6. The removable insert of claim 1, further comprising an air hole extending through the body from the inner cavity to the second end.

7. The removable insert of claim 1, wherein the inner cavity surface is cylindrical.

8. The removable insert of claim 1, wherein the inner cavity surface is a zero draft surface.

9. A molding system for forming a non-pneumatic tire, the molding system comprising:
a mold bottom assembly including
a bottom plate including
a bottom plate bore, and
a bottom outer band slot located radially outward from the bottom plate bore, the bottom outer band slot being a first annular shape concentric to the bottom plate bore, and
a bottom ridge adjacent and radially inward of the bottom outer band slot, the bottom ridge being a second annular shape,
a bottom conical plate with a first conical frustum shape coupled to the bottom plate and located radially inward from the bottom ridge, the bottom conical plate including
a bottom annular portion with a third annular shape with a bottom conical plate bore extending there through, the bottom conical plate bore aligning with the bottom plate bore, and
a bottom conical surface extending radially outward and axially toward the bottom plate forming a conical shape,
a bottom locating ring with a fourth annular shape coupled to the bottom annular portion adjacent the bottom conical surface and distal to the bottom plate, the bottom locating ring being concentric to the bottom conical plate,
an outer band with a hollow cylinder shape extending from the bottom plate in a first axial direction and being inserted into the bottom outer band slot and coupled to the bottom plate, the outer band including a band inner surface facing radially inward with a first draft angle from zero to two degrees and a band top end distal to the bottom plate,
a plurality of bottom cavity rods arranged in an annular pattern, each bottom cavity rod of the plurality of bottom cavity rods extending in the first axial direction beyond the bottom conical surface within the outer band,
a plurality of bottom cavity inserts placed over the plurality of bottom cavity rods,
a plurality of bottom tread rods coupled to the bottom plate forming a radial pattern, each bottom tread rod of the plurality of bottom tread rods being located adjacent the outer band, and
a plurality of bottom tread inserts placed over the plurality of bottom tread rods, each bottom tread insert of the plurality of bottom tread inserts including
a bottom radial wall with an annular sector shape extending up from the bottom plate along the outer band in the first axial direction, the bottom radial wall including a bottom radial molding surface facing radially inward and a bottom radial outer surface contiguous to the band inner surface, the bottom radial outer surface including a second draft angle from zero to two degrees, and
a bottom tread forming feature extending into or out from the bottom radial molding surface; and
a mold top assembly including
a top plate including
a top plate bore, and
a top outer band slot located radially outward from the top plate bore, the top outer band slot being a fifth annular shape concentric to the top plate bore and is configured to receive the band top end, and
a top ridge adjacent and radially inward of the outer band slot, the top ridge being a sixth annular shape,
a top conical plate with a second conical frustum shape coupled to the top plate and located radially inward from the top ridge, the top conical plate including
a top annular portion with a seventh annular shape with a top conical plate bore extending there through, the top conical plate bore aligning with the top plate bore, and
a top conical surface extending radially outward and axially toward the top plate forming a conical shape, and
a top locating ring with a eighth annular shape coupled to the top annular portion adjacent the top conical surface and distal to the top plate, the top locating ring being concentric to the top conical plate.

10. The molding system of claim 9, wherein the mold top assembly further includes:
a plurality of top cavity rods arranged in a second annular pattern, each top cavity rod of the plurality of top cavity rods extending in a second axial direction, opposite the first axial direction, beyond the top conical surface within the outer band;
a plurality of top cavity inserts placed over the plurality of top cavity rods;
a plurality of top tread rods coupled to the top plate forming a radial pattern, each top tread rod of the plurality of top tread rods configured to be located adjacent the outer band; and
a plurality of top tread inserts placed over the plurality of top tread rods, each top tread insert of the plurality of top tread inserts including
a top radial wall with an annular sector shape extending down from the top plate along the outer band in the second axial direction, the top radial wall including a top radial molding surface facing radially inward and a top radial outer surface configured to be contiguous to the band inner surface, the top radial outer surface including a third draft angle from zero to two degrees, and
a top tread forming feature extending into or out from the top radial molding surface.

11. The molding system of claim 9, wherein each bottom cavity rod of the plurality of bottom cavity rods includes a rod orientation feature and a rod retaining feature, and wherein each bottom cavity insert of the plurality of bottom cavity inserts includes an inner cavity extending from a first end towards a second end, an insert orientation feature within the inner cavity, and an insert retaining feature within the inner cavity.

12. The molding system of claim 11, wherein the rod orientation feature and the insert orientation feature are flat surfaces, wherein the rod retaining feature is a depression, and wherein the insert retaining feature is a protrusion extending radially inward from the inner cavity.

13. The molding system of claim 11, wherein each bottom cavity insert of the plurality of bottom cavity inserts includes an air hole extending from the inner cavity to the second end, and wherein a pin is inserted into the air hole.

14. The molding system of claim 9, wherein each bottom cavity rod of the plurality of bottom cavity rods includes a rod outer surface, the rod outer surface being a zero draft surface, and wherein each bottom cavity insert of the plurality of bottom cavity inserts includes an inner cavity including an inner cavity surface, the inner cavity surface being a zero draft surface.

15. The molding system of claim 9, wherein each bottom tread insert of the plurality of bottom tread inserts includes an inner cavity with a third draft angle from zero to two degrees, and wherein each bottom tread rod of the plurality of bottom tread rods includes a fourth draft angle from zero to two degrees.

16. The molding system of claim 9, wherein the bottom plate, the top plate, the bottom conical plate, the top conical plate, the outer band, the plurality of bottom cavity rods, and the plurality of bottom tread rods, are made of aluminum.

17. The molding system of claim 9, wherein the plurality of bottom cavity inserts, and the plurality of bottom tread inserts are made of silicon.

18. The molding system of claim 9, further comprising a rapid prototype tooling configured to form an insert, the insert being at least one of the plurality of bottom cavity inserts or one of the plurality of top tread inserts, the rapid prototype tooling including:
a top portion including
a top cover, and
a core extending from the top cover; and
a clamshell portion configured to couple to the top portion with the core extending into the clamshell including
a first clamshell, and
a second clamshell configured to couple to the first clamshell.

19. A method for modifying a mold with a mold bottom assembly and a mold top assembly for a non-pneumatic tire, the mold bottom assembly and the mold top assembly each including cavity rods extending from a plate, at least one rod being covered by an insert including a body extending from a first end to a second end and an inner cavity extending into the body from the first end towards the second end, the method comprising:
coupling a compressed air source to an air hole extending through the body from the inner cavity to the second end;
removing the insert by supplying compressed air to the inner cavity from the compressed air source and by applying a force in a first direction from the first end to the second end;
coupling the compressed air source to a second air hole of a second insert, the second insert including an outer geometry that is different than the insert; and
covering the at least one rod with the second insert by inserting the at least one rod into a second inner cavity of the second insert while supplying compressed air from the compressed air source and applying a force in a second direction opposite the first direction.

20. The method of claim 19, further comprising forming the second insert by generating a rapid prototype tooling using additive manufacturing and molding the second insert in the rapid prototype tooling.
